(19) United States
(12) Patent Application Publication
(10) Pub. No.: US 2007/0259257 A1
(43) Pub. Date: Nov. 8, 2007

(54) Handling an electrochemical cell stack

(76) Inventors: Michael Penev, EW Arnhem (NL); Adam K. Brunner, Castleton, NY (US); Richard H. Cutright, Corinth, NY (US); Michael S. Zanoni, Glen Falls, NY (US); Rhonda Staudt, Niskayuna, NY (US)

Correspondence Address: TROP PRUNER & HU, PC, 1616 S. VOSS ROAD, SUITE 750, HOUSTON, TX, 77057-2631, US

(21) Appl. No.: 11/788,782

(22) Filed: Apr. 20, 2007

Related U.S. Application Data
(60) Provisional application No. 60/793,903, filed on Apr. 21, 2006.

(51) Int. Cl. H01M 2/10; H01M 10/50

(52) U.S. Cl. 429/99; 429/123; 429/187; 429/62; 429/50

(57) ABSTRACT

An assembly includes an electrochemical cell stack and an outer insulation layer. The electrochemical cell stack includes a port to form a releasable connection with a stack handling mechanism. The outer insulation layer substantially covers the stack and an opening through the insulation layer exposes the port for connection with the stack handling mechanism.

This application claims the benefit under 35 U.S.C. §119(e) to U.S. Provisional Application Ser. No. 60/793,903, entitled “HANDLING AN ELECTROCHEMICAL CELL STACK,” which was filed on Apr. 21, 2006, and is hereby incorporated by reference in its entirety.

### BACKGROUND

The invention generally relates to handling an electrochemical cell stack.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange member (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C.) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

For some types of fuel cell stacks, it may be desirable to thermally insulate the stack. However, an outer layer of insulation on the fuel cell stack may impede the ability to move and service the stack.

Thus, there exists a continuing need for better ways to handle an electrochemical cell stack, such as a fuel cell stack, for example.

### SUMMARY

In an embodiment of the invention, an assembly includes an electrochemical cell stack and an outer insulation layer. The electrochemical cell stack includes a port to form a releasable connection with a stack handling mechanism. The outer insulation layer substantially covers the stack, and an opening through the insulation layer exposes the port for connection with the stack handling mechanism.

In another embodiment of the invention, a technique includes covering an electrochemical cell stack with an outer insulation layer to reduce thermal losses. The technique includes handling the electrochemical cell stack to physically move the stack, and the handling of the stack includes inserting at least one handle through the outer insulation layer and attaching the handle(s) to the stack. Thermal losses from the stack are mitigated by removing the handle(s) from the stack prior to operation of the stack.

Advantages and other features of the invention will become apparent from the following drawing, description and claims.

### BRIEF DESCRIPTION OF THE DRAWING

FIG. 1 is an exploded perspective view of an electrochemical cell stack assembly with a portion of an outer insulation layer removed according to an embodiment of the invention.

FIG. 2 is an illustration of a portion of the electrochemical cell stack assembly according to an embodiment of the invention.

FIG. 3 is a cross-sectional view taken along line 3-3 of FIG. 2 according to an embodiment of the invention.

FIG. 4 is an exploded perspective view of the electrochemical cell stack assembly with the handles removed according to an embodiment of the invention.

FIG. 5 is a flow diagram depicting a technique to handle and insulate an electrochemical cell stack according to an embodiment of the invention.

FIGS. 6 and 7 depict alternative handles for connection to the electrochemical cell stack assembly according to embodiments of the invention.

FIG. 8 is a schematic diagram of a fuel cell system according to embodiment of the invention.

### DETAILED DESCRIPTION

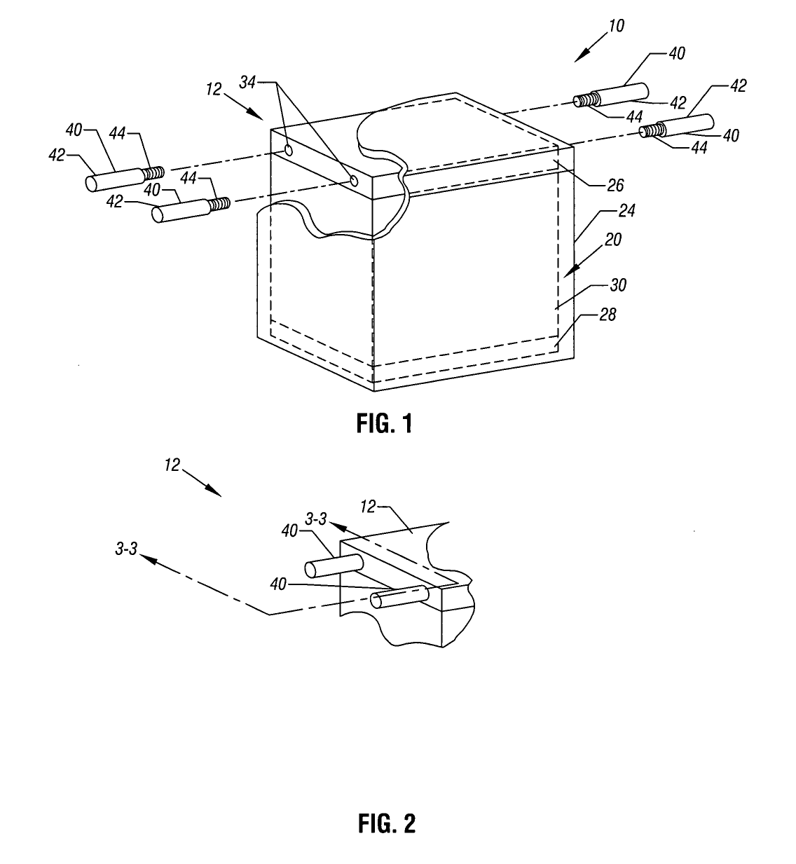

Referring to FIG. 1, in accordance with some embodiments of the invention, an electrochemical cell stack assembly 10 includes an electrochemical cell stack 20, which is covered by an outer insulation covering 24. For purposes of illustration, a portion of the insulation layer 24 is removed in FIG. 1 at the corner generally denoted by reference numeral 12. The insulation covering 24 is used for purposes of controlling thermal losses from the electrochemical cell stack 20.

More specifically, in accordance with some embodiments of the invention, the electrochemical cell stack 20 may be a fuel cell stack, such as a stack of phosphoric acid fuel cells, which operates at a relatively high temperature (a temperature in the 150° to 200° C. range, for example) and thus, the stack 20 benefits from thermal insulation to prevent parasitic losses during operation of the stack. However, a difficulty with insulating a fuel cell stack, such as phosphoric acid fuel cell stack, is that an outer layer of insulation impedes handling (physically moving, securing to a crate, moving in assembly of the fuel cell system, etc.) of the stack when the stack is not operational. Attaching handles to the fuel cell stack may aid in physically handling the stack; however, the handles may serve as conduits for heat loss during operation of the stack.

Therefore, in accordance with embodiments of the invention described herein, the electrochemical cell stack 20 includes ports 34, each of which provides a connection for releasably securing a handle 40 to the electrochemical cell stack 20 so that the handle 40 may be removed during operation of the stack 20. The handles 40 may be temporarily attached to the electrochemical stack 20 for purposes of handling the stack 20; and thereafter, the handles 40 may be removed during the stack's operation. As described further below, each of the handles 40 extends through an associated opening in the outer insulation layer 24 to connect to an associated port 34, thereby leaving the outer insulation layer 24 in place during the handling of the stack 20.

In accordance with some embodiments of the invention, each port 34 has a threaded opening that receives a corresponding threaded portion 44 of the handle 40. The handle 40 also includes a base 42 for purposes of providing a grip from which the assembly 10 can be moved. It is noted that the ports.34 may provide other types of handle connections, depending on the particular embodiment of the invention. Thus, the threaded connections are merely described herein as examples, as other embodiments are possible and are within the scope of the appended claims.

In accordance with some embodiments of the invention, the ports 34 are formed in an end plate assembly of the electrochemical cell stack 20. More specifically, the electrochemical cell stack 20 contains flow plates 30 that are disposed between upper 26 and lower 28 end plate assemblies in accordance with some embodiments of the invention. The end plate assemblies 26 and 28 maintain a compressive force on the flow plates 30 for purposes of energizing and maintaining seals of the electrochemical cell stack 20. In this example, the upper end plate assembly 26 includes the ports 34. As a more specific example, the upper end plate assembly 26 may include an end plate in which the ports 34 are formed. It is noted that the ports 34 may be secured to the electrochemical cell stack 20 in other ways, in accordance with other embodiments of the invention.

FIG. 2 generally depicts a corner 12 of the electrochemical cell stack assembly 10 (see FIG. 1), with the handles 40 attached to the assembly 10. As shown, when attached, the base portions 40 of the handles are exposed outside the outer insulation layer 24, and the base portions 44 (see FIG. 1) of the handles 40 extend through the outer insulation layer 24 and are received in the ports 34 (not depicted in FIG. 2).

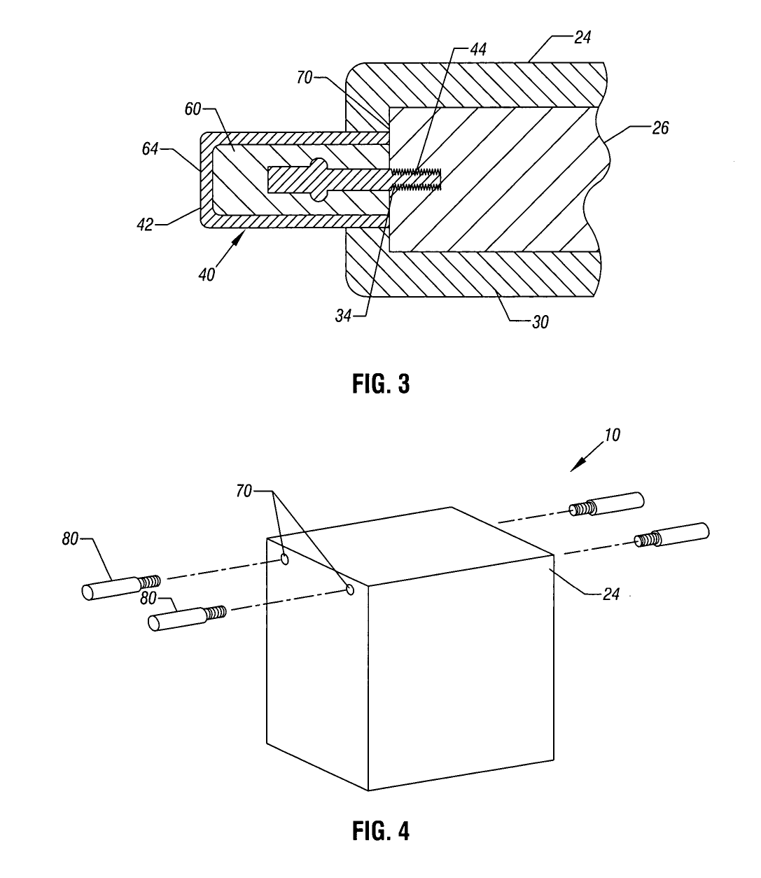

FIG. 3 depicts a cross-sectional view taken along line 3-3 of FIG. 2 in accordance with some embodiments of the invention. As depicted in FIG. 3, the handle 40 extends through an opening 70 of the outer insulation layer 24. In accordance with some embodiments of the invention, the opening 70 in the outer insulation layer 24 may be relatively small so that when the handle 40 is extracted, the opening 70 substantially closes to form a sufficient thermal seal. However, in accordance with other embodiments of the invention, after the handle 40 is retracted, the opening 70 may be sized to receive a corresponding insulation plug 80 (see FIG. 4) for purposes of preventing thermal loss through the opening 70. Still referring to FIG. 3, in accordance with some embodiment of the invention, the base 42 may include a hardened base material 60 that forms a connection with the threaded portion 44. Additionally, the handle 40 may include an outer coating 64, such as rubber, that extends over the hardened material 60 for such purposes as facilitating grip of the handle 40, reducing the temperature of the handle 40, etc.

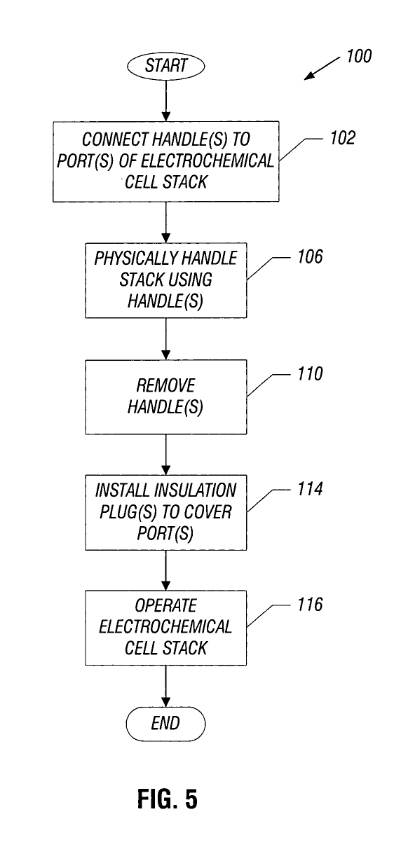

Referring to FIG. 5, to summarize, in accordance with some embodiments of the inventions a technique 100 includes connecting one or more handles to corresponding ports of electrochemical cell stack, pursuant to block 102. The stack may then be physically handled (block 106) using the handle(s). After the handling of the stack, the handle(s) may then be removed, pursuant to block 110 and then one or more insulation plug(s) may be installed (block 114) to cover the port(s). After the handle(s) have been removed and the port(s) have been covered, the electrochemical cell stack may then be operated, pursuant to block 116.

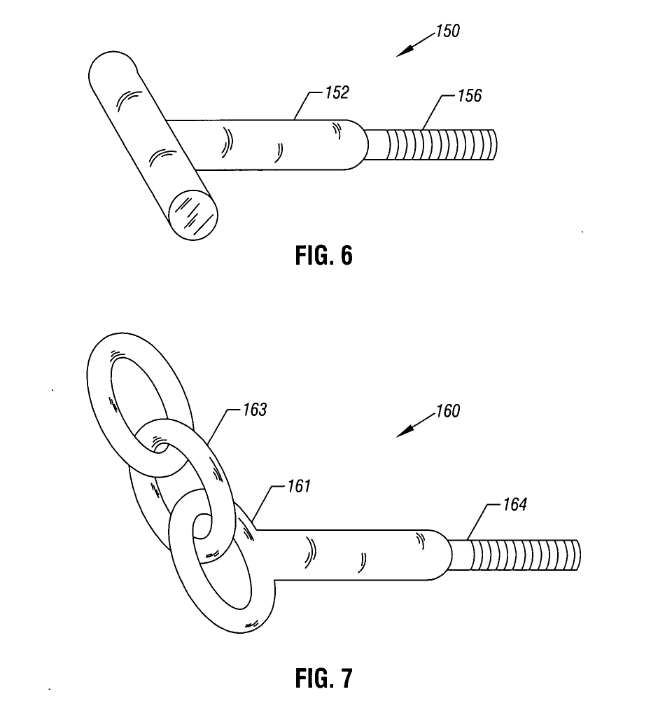

Many variations are possible and are within the scope of the appended claims. For example, FIG. 6 depicts an alternative handle 150 in accordance with some embodiments of the invention. The handle 150 is generally of the same design of the handle 40, except that the handle 150 includes a T-shaped base 152, which mates to a corresponding threaded portion 156 that is designed to be received in the port 34 to form a mechanical connection with the stack.

As an example of another variation, FIG. 7 depicts a handle 160 that may be used, for example, for purposes of attaching the electrochemical cell assembly 10 to a forklift. More particularly, the handle 160 includes a base portion 160 that attaches a chain 163 to the handle 160. A threaded portion 164 is attached to the base 161 for purposes of attaching the handle 160 to the electrochemical cell stack assembly 10. Thus, the chain 163 may be used for purposes of securing the electrochemical cell stack assembly 10 to a forklift for physical handling of the assembly 10.

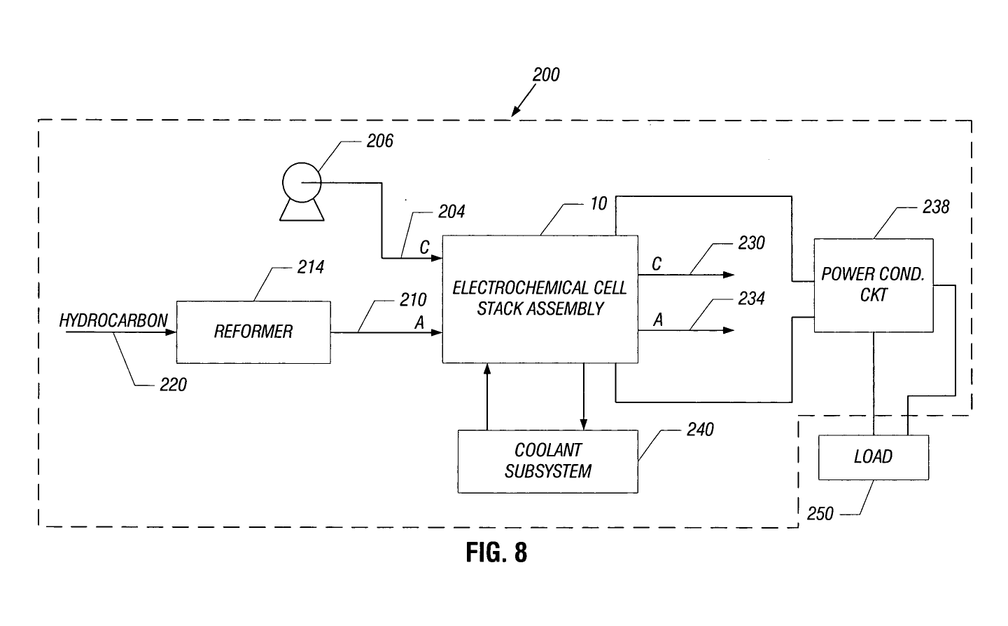

The electrochemical cell stack assembly 10 may be part of a fuel cell system 200, in accordance with some embodiments of the invention. As depicted in FIG. 8, the fuel cell system 200 may provide electrical power for a load 250, which may be a residential or commercial load, depending on the particular embodiment of the invention. The electrochemical cell stack assembly 10 includes a cathode inlet 204 that receives an incoming oxidant flow from an air blower 206, for example. An anode inlet 210 of the electrochemical cell stack assembly 10 receives an incoming reformate flow from a reformer 214, for example. The reformer 214 produces the reformate in response to a hydrocarbon flow 220, which is received by the reformer 214.

The incoming oxidant and fuel flows are communicated through the electrochemical cell stack assembly 10 through corresponding cathode and anode sides of the assembly 10. A cathode exhaust outlet 230 provides the corresponding cathode exhaust from the cathode side of the electrochemical cell stack assembly 10, and an anode exhaust outlet 234 provides the corresponding anode exhaust flow from the anode side of the electrochemical cell stack assembly 10. In accordance with some embodiments of the invention, the cathode exhaust may be routed at least in part back to the reformer 214. Additionally, a contaminant trap, such as a phosphoric acid scrubber may be located in the path of the cathode exhaust between the cathode exhaust and the reformer 214, in accordance with some embodiments of the invention. The anode exhaust may be routed, at least in part, back to the anode inlet 210 in accordance with some embodiments of the invention. However, in accordance with other embodiments of the invention, the anode exhaust may be directed to an oxidizer or flare.

Among the other components of the fuel cell system 200, in accordance with some embodiments of the invention, the system 200 may include power conditioning circuitry 238 that receives electrical power from the electrochemical cell stack assembly 10 and conditions the power into the appropriate form for the load 250. For example, in accordance with some embodiments of the invention, the load 250 may be an AC load, and for these embodiments of the invention, the power conditioning circuitry 238 transforms the DC power from the electrochemical cell stack assembly 10 into the appropriate DC level before an inverter of the power conditioning circuitry 238 converts the DC power into the appropriate AC level for the load 250. The power conditioning circuitry 238 may convert the DC power provided by the electrochemical cell stack assembly into a DC output voltage for the load 250, in accordance with other embodiments of the invention. Thus, many variations are possible and are within the scope of the appended claims. Additionally, in accordance with some embodiments of the invention, the fuel cell system 200 may include a coolant subsystem 240 that circulates a coolant through the electrochemical cell stack assembly 10 for purposes of regulating the temperature of its operation.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An assembly comprising:
an electrochemical cell stack comprising a port to form a releasable connection with a stack handling mechanism;
an outer insulation layer to substantially cover the stack; and
an opening through the insulation layer to expose the port for connection with the stack handling mechanism.

2. The assembly of claim 1, wherein the stack handling mechanism comprises a handle.

3. The assembly of claim 1, wherein the stack handling mechanism comprises a forklift connection.

4. The assembly of claim 1, further comprising:
an insulating plug to close the opening.

5. The assembly of claim 1, wherein the electrochemical stack comprises a fuel cell stack.

6. The assembly of claim 1, wherein the electrochemical stack comprises an end plate assembly, and the port is formed in the end plate assembly.

7. The assembly of claim 1, wherein the port comprises threads to form a threaded connection with the stack handling mechanism.

8. The assembly of claim 1, further comprising:
additional ports to form releasing connections with other stack handling mechanisms.

9. The assembly of claim 8, wherein the electrochemical cell stack comprises an end plate assembly and said additional ports are located in the end plate assembly.

10. A method comprising:
covering an electrochemical cell stack with an outer insulation layer to reduce thermal losses;
handling the stack to physically move the stack, the handling comprising inserting at least one handle through the outer insulation layer and attaching said at least one handle to the electrochemical cell stack; and
controlling thermal losses from the stack, comprising removing said at least one handle after the handling to prevent the losses through said at least one handle during operation of the electrochemical cell stack.

11. The method of claim 10, wherein the handling comprises attaching a handle to the stack.

12. The method of claim 10, wherein the handling comprises using a forklift to move the stack.

13. The method of claim 10, wherein the controlling comprises:
closing the outer insulation layer where each handle was previously inserted through the outer insulation layer.

14. The method of claim 10, wherein the electrochemical stack comprises a fuel cell stack.

15. The method of claim 10, further comprising:
forming a releasable connection for each handle in the electrochemical cell stack;

16. The method of claim 10, wherein the forming comprises:
forming each releasable connection in an end plate assembly of the electrochemical cell stack.
